(19) United States
(12) Patent Application Publication
(10) Pub. No.: US 2018/0129481 A1
(43) Pub. Date: May 10, 2018

(54) METHOD AND COMPUTER FOR DETERMINING SELECTION CONNECTION STRUCTURES IN A GRAPHICS COMPUTER PROGRAM

(71) Applicant: Siemens Healthcare GmbH, Erlangen (DE)

(72) Inventor: Jan Kretschmer, Nuernberg (DE)

(73) Assignee: Siemens Healthcare GmbH, Erlangen (DE)

(21) Appl. No.: 15/806,720

(22) Filed: Nov. 8, 2017

(30) Foreign Application Priority Data
Nov. 8, 2016 (EP) 16197756

(51) Int. Cl. G06F 9/44; G06N 3/08

(52) U.S. Cl. CPC G06F 8/20; G06N 3/08; G06F 8/34

(57) ABSTRACT

In a method for providing suitable selection connection structures in a graphics programming language for a selection module, first connection structures of at least one first module are determined in a computer, the first connection structures and the first module being contained in graphics training program sections. A selection module and an existing connection structure of the selection module are also received in the computer, the selection module being contained in a graphics computer program, and the existing connection structure designating the connection structure of the selection module in the graphics computer program. Selection connection structures are also chosen from the volume of first connection structures, wherein each of the selection connection structures is a connection structure of the selection module, and wherein each of the selection connection structures comprises the existing connection structure of the selection module.

### BACKGROUND OF THE INVENTION

### Field of the Invention

Visual programming is a modality for creating a graphics computer program. Modules having defined interfaces for inputs and outputs are provided for the programmer, and these can carry out the elementary tasks or represent input and/or output units. By combining these modules using connections, the programmer can create complex computer programs. A graphics computer program can be translated by a compiler into a computer program, and the computer program can then be used independently of a runtime environment on other computers, microcontrollers or arithmetic processors.

### Description of the Prior Art

Despite a superficially simple representation, the creation of a complex computer program is usually possible only by an experienced programmer in a time-consuming manner. For example, the programmer must have knowledge of the mode of operation of the individual usable modules and the interfaces provided by them. In particular, the choice of a module, which expands an existing graphics computer program, and its correct inclusion in a graphics computer program are complex and require a lot of experience on the part of the programmer.

Various systems for visual programming have different approaches for rendering this task practicable for the programmer and/or to accelerate it. A simple and popular possibility is to provide one or more tutorial(s) which explain fundamental functions. More in-depth possibilities are the provision of example applications and of reference documentation of the existing modules and interfaces. As a further possibility it is known to display other modules for each interface of a module, and these can be linked via this interface to the module. A further possibility is to display examples of the embedding of a module in a graphics computer program directly in the graphics programming interface.

However, these existing possibilities have some drawbacks. Extensive reference documentation firstly has to be worked through by a programmer. A search for solutions to a specific problem in reference documentation is therefore time-consuming. Examples must be maintained by an expert since the usage profile of modules can change due to new developments or new modules. If it is possible to generate user-defined modules and use them in graphics programs in the graphics programming, then these must similarly be provided by the creator with reference documentation or with examples. The use of a module can also differ in different fields of application or even in the case of different programmers from the originally provided application example. Finally, faults can occur when the present examples are transferred into the graphics programming environment.

### SUMMARY OF THE INVENTION

An object of the present invention is to provide a method that enables faster and more efficient creation of a graphics computer program.

The inventive solution to the object will be described below with reference to a computer as well as with reference to a method. Features, advantages and alternative embodiments mentioned in the context of the method are applicable to the computer, and vice versa. The functional features of the method are formed by appropriate physical modules in the computer.

The invention is based on first connection structures of a section in a graphics training program at least one first module in another section of the graphics training program being determined by an arithmetic processor of a computer. Furthermore, a selection module and an existing connection structure of the selection module are received via an interface of the computer, the selection module being contained in a graphics computer program. The existing connection structure designates the connection structure of the selection module in the graphics computer program. Furthermore, selection connection structures are selected from the volume of first connection structures by the arithmetic processor selection, wherein each of the selection connection structures is a connection structure of the selection module, and wherein each of the selection connection structures is one of the existing connection structure of the selection module.

The invention is based on the insight that examples in the form of selection connection structures can be derived for different fields of application of a module by inventive determining of the first connection structures from the graphics training program sections, without these examples having to be created or managed by a programmer. The first connection structures can be determined by an analysis of the graphics training program sections.

Inappropriate selection connection structures thus are not chosen, and the required time for the selection of the appropriate connection structure from the selection connection structures is thereby reduced, because the existing connection structure of the selection module is considered during the first selection, and only selection connection structures are selected that include this existing connection structure of the selection module.

The graphics training program sections can be individually adapted to the programmer. For example, it is possible to use only graphics training program sections that the programmer has personally created. Alternatively, graphics training program sections of a group of programmers who work on similar tasks or on similar graphics computer programs can also be used. As a result, determining of the first connection structures can be performed individually for the programmer or the intended application. As a result, the selection connection structures are better adapted to the programmer or the intended application, and the required time for the selection of the appropriate connection structure from the selection connection structures is reduced.

According to a further aspect of the invention, determining of the first connection structures occurs before receiving of the selection module and the existing connection structure of the selection module. Furthermore, according to this aspect of the invention, the first module has at least the most frequent modules contained in the graphics training programs. As a result of this aspect, it is possible to perform necessary calculations and sorting processes as early as before the beginning of the actual programming work. In this context, “before the beginning of the actual programming activity” means, at the start of the graphics programming environment, although the necessary pre-calculations can also be performed on a server in particular time intervals. Since determining occurs at least for the most frequent module occurring in the training program sections, the calculations and sorting processes are carried out for a module that is also very likely used in the graphics computer program. As a result of these calculations and sorting processes, the time from receiving of the selection module through to the first selection of the selection connection structures is reduced, since querying of all graphics training program sections is no longer necessary after receiving of the selection module. It is also possible to perform the calculations and sorting processes for a number of first modules. If the selection module is not contained in the first modules, the determining has to be carried out again, with the first module then being the selection module.

According to a further embodiment of the invention, the first modules include all modules that are contained in the graphics training program sections. A very large number of necessary calculations and sorting processes thus can be performed before the beginning of the programming activity. This leads to very few calculations being required after receiving of the selection module, and the first selection of the selection structures being particularly fast.

According to a further embodiment of the invention, receiving of the selection module occurs before determining of the first connection structures. Furthermore, according to this embodiment of the invention, the first module is the selection module. The invention is based on the insight that it is possible with this design to carry out the method with a particularly low storage requirement and a particularly short time requirement for pre-calculations. Furthermore, is it thereby possible to consider changes in the training program sections, which occur between the beginning of the programming process and receiving of a selection module, with the selection connection structures.

According to a further embodiment of the invention, the method includes calculating weighting factors of the first connection structures, or the selection connection structures, based on the graphics training program sections, by the arithmetic processor. Using these weighting factors, sorting of the selection connection structures is possible dependent on their respective importance. As a result, a programmer can identify more quickly and efficiently which of the proposed examples is best suited for the specific situation.

According to a further embodiment of the invention, the weighting factor of a connection structure relates to at least one weighted relative frequency of the occurrence of the connection structure in the graphics training program sections. Furthermore, there is a weighting of the relative frequencies with a rating factor which is associated with a graphics training program section. The relative frequency of a connection structure is a measure of the importance of a connection structure that should be determined quickly and efficiently. A connection structure, which frequency occurs in the graphics training program sections, is very likely a standard example of the use of the selection module. A connection structure, which occurs only rarely in the graphics training program sections, is very likely a solution to a special case or even an incorrect solution. Particular graphics training program sections can be preferred by weighting the relative frequency with a rating factor, with the rating factor relating to a graphics training program section. For example, it is conceivable to weight training program sections of experienced programmers more highly than those of inexperienced programmers. Furthermore, it is conceivable to weight separate training program sections of one programmer more highly than training program sections of a different programmer.

According to a further embodiment of the invention, the same rating factor is associated with each graphics training program section. This implies that the weighting factor of a connection structure corresponds to the relative frequency of the occurrence of this connection structure in the graphics training program sections. The individual graphics training program sections do not have to first be evaluated under this aspect of the invention in order to be considered during the calculation of the weighting factors and consequently during the first selection of selection connection structures. As a result, graphics training program sections are available more quickly as a basis of calculation for the weighting factor; the omission of rating simultaneously increases the efficiency of the method.

According to a further embodiment of the invention, calculating of the weighting factor of a connection structure occurs using a self-learning algorithm or network based on the graphics training program sections. The use of a self-learning network has the advantage that a very large number of factors can be incorporated in the calculation of the weighting factor of a connection structure, and that even complicated connections and correlations between the graphics training program section and the connection structure of the first module can be detected by the self-learning network. For example, a correlation between an input module and the connection structure of an output module, between which further modules are located, with the modules located therebetween differing in the individual graphics training program sections, can be determined more efficiently by a self-learning network than by a pure frequency analysis.

According to a further embodiment of the invention, the self-learning network is an artificial neural network that, in a training phase, maps graphics training program sections without the selection module on graphics training program sections including the selection module and including a connection structure of the selection module. An artificial neural network is a particularly robust self-learning network, with robust meaning that extremely few parameters are relevant for prediction of the self-learning procedure, and only a small number of parameters have to be set by a user. Furthermore, an artificial neural network can determine complex connections and correlations particularly well.

According to a further embodiment of the invention, the method includes the second selection of a selected connection structure from the selection connection structures by the arithmetic processor, and supplementing the connection structure of the selection module based on the selected connection structure by means of the arithmetic processor. As a result of automatic supplementing of the connection structure of the selection module based on the selected connection structure, graphics programming can take place particularly quickly and, in addition, this automatic supplementing is not susceptible to faults.

According to a further embodiment of the invention, the second selection of the selected connection structure is made from the selection connection structures by the weighting factor. If the selection is made by a programmer, then he or she can select the connection structure suitable for the desired intended use particularly quickly using the weighting factor. If, by contrast, the selection is made completely automatically, then no interaction of the programmer with the programming environment is therefore required for selection of the suitable connection structure. Expansion of the graphics computer program is similarly possible particularly quickly.

According to a further embodiment of the invention, the connection structure of the first module includes only second modules, which are contained in the vicinity of the first order of the first module. Furthermore, a connection structure includes all connections between the first and the second modules. A limitation to the modules in the vicinity of the first order of the first module includes the fundamental information about the use of the first module in a graphics computer program if all connections between the modules are considered. At the same time, this limitation significantly reduces the storage requirement and the computing requirement in carrying out the method.

Furthermore, the invention relates to a computer for determining selection connection structures, that has the following components.

An interface is designed to receive a selection module and an existing connection structure of the selection module, wherein the selection module is contained in a graphics computer program, and wherein the existing connection structure designates the connection structure of the selection module in the graphics computer program.

An arithmetic processor configured to determine first connection structures of at least one first module, wherein the first connection structures and the first module are contained in graphics training program sections. The arithmetic processor is also configured to make first selection of selection connection structures from the volume of first connection structures.

Each of the selection connection structures is a connection structure of the selection module, and each of the selection connection structures includes the existing connection structure of the selection module.

The determining computer is thus designed to carry out the above-described inventive method and all its embodiments.

The present invention also encompasses a non-transitory, computer-readable data storage medium encoded with programming instructions that, when the storage medium is loaded into a computer, cause the computer to execute any or all of the embodiments of the method according to the invention, as described above.

A graphics computer program is a collection of modules or routines, and connections, the connections each connecting two, in particular exactly two, modules. The arrangement of modules and connections constitutes a calculation rule with which input data of the graphics computer program can be transformed to output data of the graphics computer program. A graphics computer program segment is part of a graphics computer program. The creation of a graphics computer program by a programmer is designated graphics programming. Graphics programming usually occurs by a graphics programming interface in which at least one graphics computer program is presented.

A module is a completed function, which maps (potentially non-existent) input data on (potentially non-existent) output data, with mapping optionally occurring by considering the parameters associated with the module. In particular, a module can be a pure function which is independent of the state of the graphics computer program and does not have any side effects on the graphics computer program. A module can include input interfaces and output interfaces, with it being possible to associate one data type with each of the input interfaces and each of the output interfaces.

A module can be contained in different graphics computer programs or graphics computer program segments. A module can, moreover, be contained multiple times in the same graphics computer program or multiple times in the same graphics computer program segment.

A connection connects an output interface of a first module to the input interface of a second module. An existing connection of this kind means that during execution of the graphics computer program, the output data of the first module is used as input data of the second module. If one data type is associated with the input interface and/or the output interface, the data type of the first input interface and the data type of the output interface must be compatible or the same. An output interface can be connected to a number of input interfaces of one or more module(s).

A module without input interfaces is an input module. An input module can be used to introduce data into the graphics computer program. This data can be, for example, computer data files, user inputs, output data of other independent programs or um measuring results of at least one measurement device. A module without output interfaces is an output module. An output module can be used to extract data from the graphics computer program. An output module can, in particular, be associated with a display unit (such as a screen or part of a screen), a printing unit or a computer file. An output module can, however, also be used to forward the output of the graphics computer program to a further computer program independent thereof.

Two modules in a graphics computer program are adjacent if a connection exists in the graphics computer program which connects the two modules. The vicinity of the first order of a first module comprises all modules which are adjacent to the first module. The vicinity of the N^{th} order of a first module comprises the vicinity of the (N−1)^{th} order of the first module and all modules which are adjacent to a module of the vicinity of the (N−1)^{th} order of the first module.

A connection structure of a first module includes the first module and at least one subset of a vicinity of any order of the first module in a graphics computer program or in a graphics computer program segment, as well as a subset of the connections between these modules in the graphics computer program or in the graphics computer program segment. A subset of a volume can also be the empty volume, but it can also be the entire volume. A first connection structure includes a second connection structure if all modules and connections of the second connection structure are contained in the first connection structure. A connection structure can be contained in one or more computer programs and/or computer program segments.

The existing connection structure of a selection module in a graphics computer program is the connection structure of this selection module in the graphics computer program. The existing connection structure can also be contained in one or more graphics training computer program segment(s). Furthermore, first connection structures of first modules or selection connection structures of the selection module can include the existing connection structure.

A weighting factor of a connection structure is a number or a vector for evaluating or arranging a number of connection structures. A weighting factor can, in particular, relate to the relative frequency of a connection structure of a module in a volume of graphics computer programs. A weighting factor can also relate to a rating factor of a graphics computer program. In particular, a weighting factor W(V) of a connection structure V can be determined with the formula

$$W ( V ) = \frac{{\sum }_{i = 1}^{N} δ ( {G}_{i} , V ) \cdot B ( {G}_{i} )}{{\sum }_{i = 1}^{N} B ( {G}_{i} )}$$

where Gᵢ designates the i^{th} of the N graphics training program sections and B(Gᵢ) the rating factor thereof. Furthermore, δ(Gᵢ,V) designates an indicator function, where δ(Gᵢ,V)=1 applies if the connection structure V is contained in the graphics training program section G, and otherwise δ(Gᵢ,V)=0 applies. If the same rating factor is used for each training program section, this formula is simplified to

$$W ( V ) = \frac{1}{N} {\sum }_{i = 1}^{N} δ ( {G}_{i} , V )$$

The self-learning network determines a transformation function which maps an input data set onto an output data set, with the transformation function being determined by training. A self-learning network can be based, for example, on an artificial neural network which maps an input data set onto an output data set by means of linear or non-linear transformations and weights to be determined. The weights of the artificial neural network can be determined, in particular, by training, for example by using the backpropagation algorithm using existing associations of input data sets with output data sets.

### BRIEF DESCRIPTION OF THE DRAWINGS

FIG. 1 is a flowchart of the method according to the invention.

FIG. 2 is a flowchart of a further embodiment of the method according to the invention.

FIG. 3 illustrates a graphics computer program according to the invention.

FIG. 4 illustrates a selection module having a selection connection structure according to the invention.

FIG. 5 illustrates the selection module having a further selection connection structure according to the invention.

FIG. 6 is a block diagram of a determining computer for determining selection connection structures according to the invention.

### DESCRIPTION OF THE PREFERRED EMBODIMENTS

FIG. 1 is a flowchart of an exemplary embodiment of the method for determining selection connection structures according to the invention.

The first step of the exemplary embodiment of the method is determining DET first connection structures of at least one first module by means of an arithmetic processor 602, with the first connection structures and the first module being contained in graphics training program sections 610.1, 610.2. The training program sections 610.1, 610.2 are saved in a database 606. All modules which are part of a program segment of the graphics training program sections 610.1, 610.2 are used as first modules. Furthermore, first connection structures of the first modules are determined by the database 606, wherein, in the illustrated exemplary embodiment, all connection structures respectively of the first modules, which are contained in a program segment of the graphics training program sections 610.1, 610.2, are retrieved. Alternatively, it is also possible to use just some of all modules as the first modules. These can, in particular, be modules which are frequently or most frequently contained in a program segment of the graphics training program sections 610.1, 610.2. In the illustrated exemplary embodiment, the first connection structures are sorted according to the associated first module, so during the subsequent course of the method all first connection structures of a first module can be retrieved very quickly.

In the illustrated exemplary embodiment, the first connection structures of the first modules comprise only second modules from the vicinity of the first order of the first module, the connection structures of the first modules comprise, moreover, all connections between the first module and the second modules which are contained in a graphics computer program or in a graphics computer program segment. Alternatively, the first connection structures of the first modules can also comprise modules from a vicinity of a higher order of the first module, in particular the second or third order. Alternatively, a connection structure can also contain further modules and connections in the graphics computer program or in the graphics computer program segment. Connection structures of the first modules can, however, also include just a subset of the connections between the first module and the second modules contained in a graphics computer program or in a graphics computer program segment.

The next step of the method is calculating CALC weighting factors of the first connection structures. A weighting factor is here the relative frequency of the occurrence of a connection structure in the training program sections 610.1, 610.2. The relative frequency is weighted with a rating factor, wherein the rating factor is associated with a training program section 610.1, 610.2. The rating factor can, in particular, evaluate who created the training program section 610.1, 610.2. For example, it is conceivable that training program sections 610.1, 610.2, which a particular programmer created, are rated particularly high. A further possibility is that examples of connection structures, which the developer of a module provided, are rated particularly high. A weighting factor of a connection structure can, in particular, be calculated in that the rating factors of the training program sections 610.1, 610.2, in which the connection structure is contained, are added. The weighting factor of a connection structure of a first module can also be normalized as the weighting factor of a connection structure of a first module is divided by the total of the weighting factors of all connection structures of the first module. Alternatively, the weighting factor can also be determined with a self-learning network. The self-learning network can be an artificial neural network.

In the illustrated exemplary embodiment of the method, determining DET and calculating CALC ideally occur on an arithmetic server 607 which is connected to a determining computer 600. The arithmetic server 607 can be located, in particular, at a geographically different location to the determining computer 600. The arithmetic server 607 can also be designed as a group of server arithmetic processors. The term cluster is known for this. The arithmetic server 607 can also be connected to a large number of determining computers 600. In the illustrated exemplary embodiment of the method, determining DET and calculating CALC can be carried out independently of the remaining method steps time-wise, for example every time a programmer calls up the graphics programming environment, or at a fixed interval, for example hourly or daily. Determining DET and calculating CALC can ideally be carried out by weighting factors as soon as a new training program section is added to the training program sections 610.1, 610.2.

The next step of the illustrated exemplary embodiment of the method is receiving REC a selection module 401 and an existing connection structure 501 of the selection module 401. The selection module 401 can be selected by the programmer in the user interface of the graphics computer program. In the illustrated exemplary embodiment, selection of the selection module 401 is made by clicking the selection module 401, already present in the graphics computer program, using the mouse 604.3. Selection of the selection module 401 can alternatively also be made automatically, however, by selecting the module most recently inserted into the graphics computer program 300 as the selection module 401. In the illustrated exemplary embodiment, receiving REC of the selection module 401 selected by the mouse 604.3 occurs by means of the interface 601. The interface 601 can therefore be designed, in particular, as a USB interface. The existing connection structure 501 of the selection module 401 can also comprise just the selection module 401 itself, and no further modules or connections. This is the case if a selection module 401 in the graphics computer program 300 does not have an associated connection. In addition to the selection module 401 and the existing connection structure 501 of the selection module 401, other data can also be received which can be used in the further method steps. For example, the data can relate to the order of insertion of all existing modules and/or connections in the present graphics computer program.

The next step of the illustrated exemplary embodiment of the method is the first selection SEL-1 of selection connection structures 400, 500 from the first connection structures by means of the arithmetic processor, wherein the first module corresponds to the selection module 401, and wherein the selection connection structures 400, 500 comprise the existing connection structure 501 of the selection module 401. Since in the illustrated exemplary embodiment of the method the first connection structures were sorted using the associated first modules during determining DET, the first connection structures can be used very easily by indicating the selection module 401 during the first selection SEL-1. For each first connection structure a check is then carried out as to whether the first connection structure comprises the connection structure 501 of the selection module 401 existing in the graphics computer program. For this, a check is carried out for each module 501 of the existing connection structure 501 as to whether this module 501 is contained in the first connection structure, and whether this module 501 is connected in the first connection structure by means of a connection to the same interface 402.1 of the selection module 401 as in the existing connection structure 501. The selection connection structures 400, 500 can be displayed for the programmer together with the weighting factor. In particular, one of the selection connection structures 400, 500 can be displayed in the graphics programming interface as an expansion of the graphics computer program 300, and at the same time a selection element can be superimposed which enables selection of a different selection connection structure 400, 500 to be displayed at least according to the weighting factor.

The next step of the method is the second selection SEL-2 of a selected connection structure from the selection connection structures 400, 500. From the illustrated selection connection structures 400, 500 the programmer can select the one which best meets the requirements of the graphics computer program to be created. For this, he can select in a context menu that the selection connection structure 400, 500 currently being displayed should be used in the graphics computer program. Alternatively, the second selection SEL-2 of the selected connection structure 400, 500 can also be made automatically by determining the selection connection structure 400, 500 with the highest weighting factor.

The last step of the illustrated method is the supplementing SUPL of the existing connection structure 501 of the selection module 401 based on the selected connection structure. Here all modules and connections of the selected connection structure are inserted in the graphics computer program if they are not already present in the existing connection structure and are thereby present in the graphics computer program.

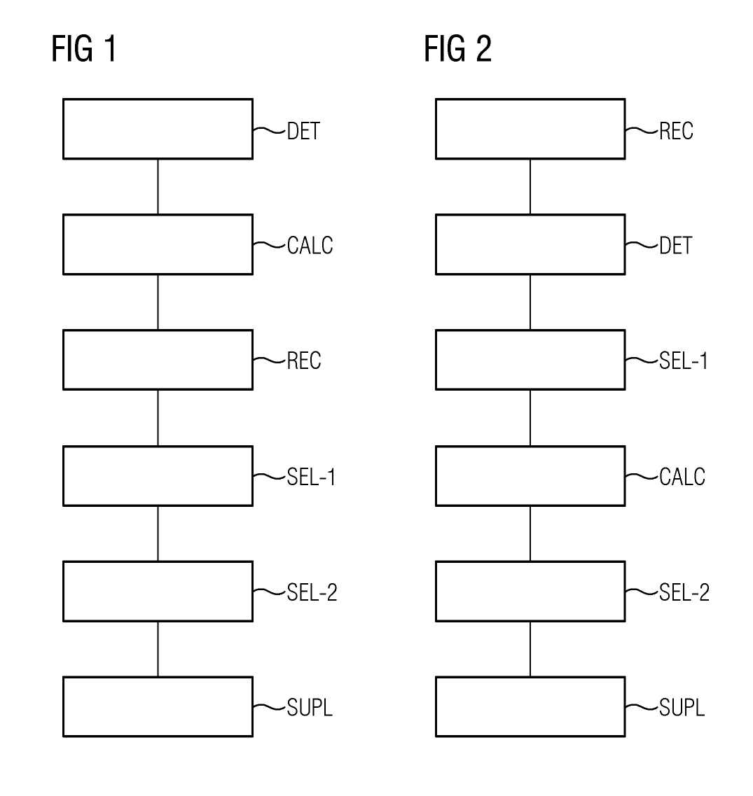

FIG. 2 shows a further flowchart of a further exemplary embodiment of the method. The first step in this exemplary embodiment is receiving REC of a selection module 401 and the existing connection structure 501 of the selection module 401 by means of the interface 601. The next step is determining DET first connection structures of at least one first module in graphics training program sections 610.1, 610.2 by means of the arithmetic processor 602. In this exemplary embodiment determining DET relates to just the selection module 401 as the first module. The next step is the first selection SEL-1 of selection connection structures 400, 500 from the first connection structures, with the selection connection structures 400, 500 comprising the existing connection structure 501 of the selection module 401. Since in this exemplary embodiment determining DET relates to just the selection module 401 as the first module, the first step of the first selection SEL-1 is trivial. The next step in the described example is calculating CALC weighting factors for each of the selection connection structures 400, 500. Unlike with the exemplary embodiment illustrated in FIG. 1, the weighting factor therefore only has to be calculated for those connection structures which relate to the selection module 401 and which comprise the existing connection structure 501 of the selection module 401. As in the exemplary embodiment illustrated in FIG. 1, the second selection SEL-2 of a selected connection structure from the selection connection structures 400, 500 and supplementing SUPL of the connection structure of the selection module 401, based on the selected connection structure, follow as further steps.

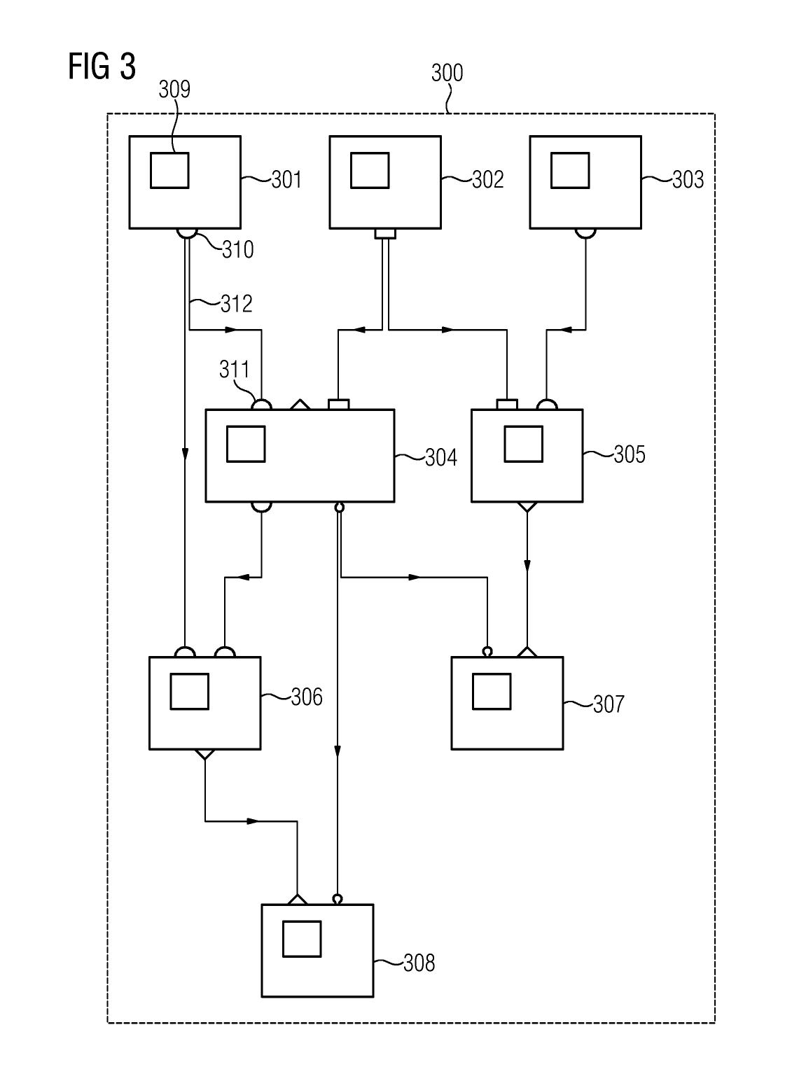

FIG. 3 shows a graphics computer program 300. The graphics computer program 300 comprises input modules 301, 302 and 303, output modules 307, 308 and further modules 304, 305 and 306. A certain parameter set can be associated with each of the modules 301 to 308; here the parameters 309 are associated with the module 301. Each module 301 to 308 comprises at least one input interface 311 and/or at least one output interface 310. An output interface 310 of a module 301 can be connected by a connection 312 to an input interface 311 of a further module 304. The presence of a connection 312 states that the result data of the module 301 is transmitted to the module 304 during the course of the graphics computer program. An output interface 310 of a module 301 can be a starting point of a plurality of connections 312, the output data of the module 301 is then transmitted to a plurality of different modules as input data here. In the exemplary embodiment shown here it is not possible for an input interface 311 of a module 304 to be the input interface 311 of a plurality of connections. If it is necessary for one module 304 to receive a number of input data of the same data type, the module must have a plurality of input interfaces 311 of this data type. Alternatively, input interfaces 311 having a plurality of connections 312 are also possible, in particular if the order of the input data of the same data type is irrelevant. If the order of input data is relevant, the order can then be implemented by the graphics arrangement of the connections (for example from right to left or from top to bottom).

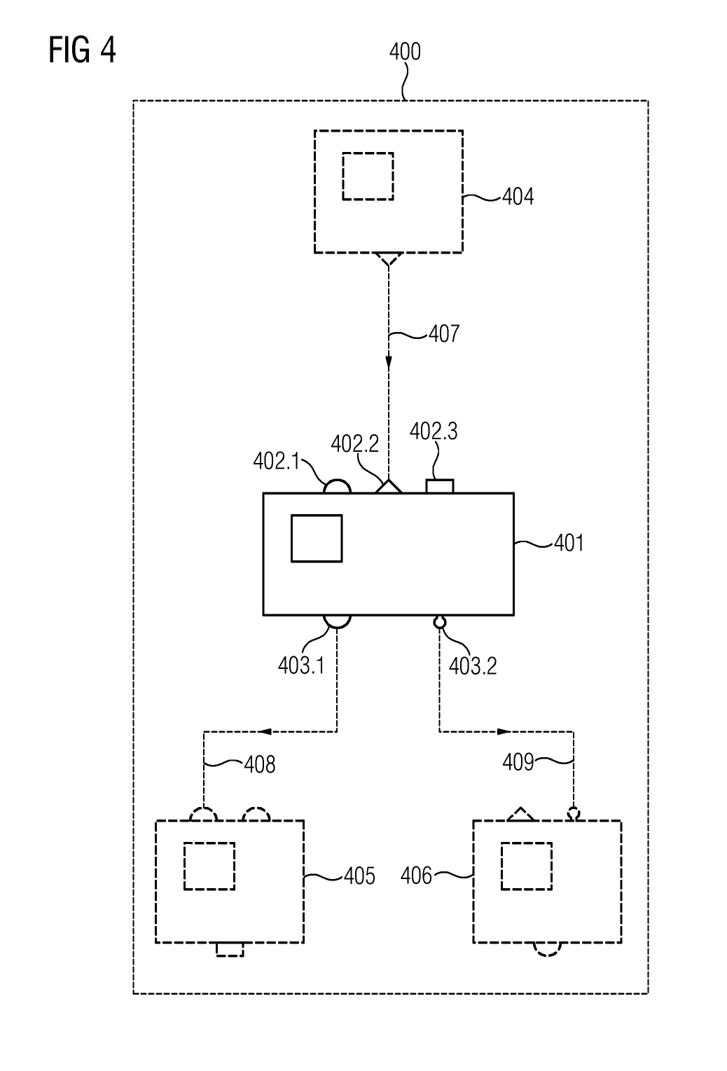

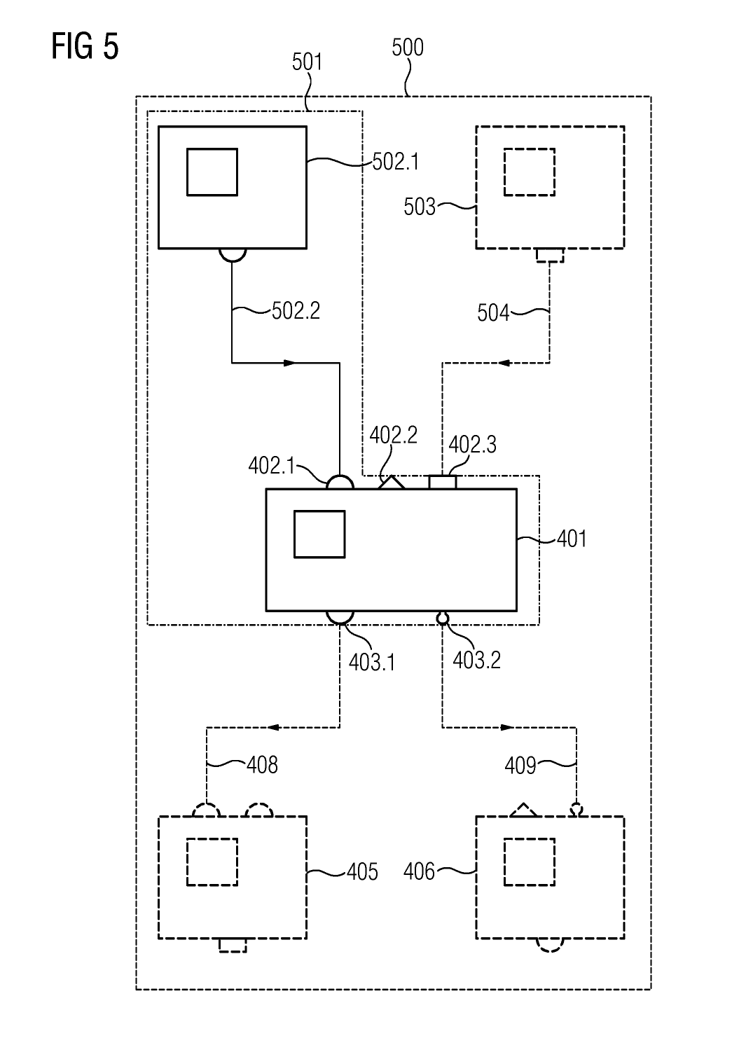

FIG. 4 shows a selection module 401 together with a selection connection structure 400. The selection module 401 includes input interfaces 402.1, 402.2, 402.3 and output interfaces 403.1, 403.2. In the illustrated example the existing connection structure comprises no further modules or connections apart from the selection module 401. Therefore, each first connection structure of the selection module 401 can be used as a selection connection structure 400, 500. The illustrated selection connection structure 400 comprises three modules 404, 405, 406 which are connected by means of connections 407, 408, 409 to the selection module 401. Here the module 404 is connected by the connection 407 to the input interface 402.2 of the selection module 401, the module 405 is connected by the connection 408 to the output interface 403.1 of the selection module 401, the module 406 is connected by the connection 409 to the output interface 403.2 of the selection module 401. In a selection connection structure 400, 500 it is not necessary for each interface of the selection module 401 to have a connection to a further module. In the illustrated selection connection structure 400 the interfaces 402.1 and 402.3 of the selection module 401 are not connected to a further module.

FIG. 5 shows a further selection connection structure 500 of the selection module 401. In contrast to the selection connection structure 400 illustrated in FIG. 4, the selection module 401 in the graphics computer program 300 is already connected to a further module 502.1 by a connection 502.2 and by the interface 402.1 of the selection module 401. Therefore, the existing connection structure 501 here comprises another module 502.1 and a connection 502.2 in addition to the selection module 401. The first selection SEL-1 therefore relates to only selection connection structures 500 which comprise the existing connection structure 501. This figure illustrates a selection connection structure 500 which comprises the modules 405, 406 and 503 and connections 408, 409 and 504 in addition to the module 502.1 of the existing connection structure and the connection 502.2 of the existing connection structure. Here the module 503 is connected by the connection 504 to the input interface 402.3 of the selection module 401. Furthermore, the module 405 is connected by the connection 408 to the output interface 403.1 of the selection module 401. Furthermore, the module 406 is connected by the connection 409 to the output interface 403.2 of the selection module 401.

In the two examples illustrated in FIG. 4 and FIG. 5, the parts of the selection connection structure 400, 500, which are not incorporated by the existing connection structure 501 of the selection module 401, are illustrated by broken lines. This serves to distinguish modules and connections actually present in the program from the proposed connections and modules of the illustrated selection connection structure 400, 500. Alternatively, the distinction can also be enabled by different colors or brightness.

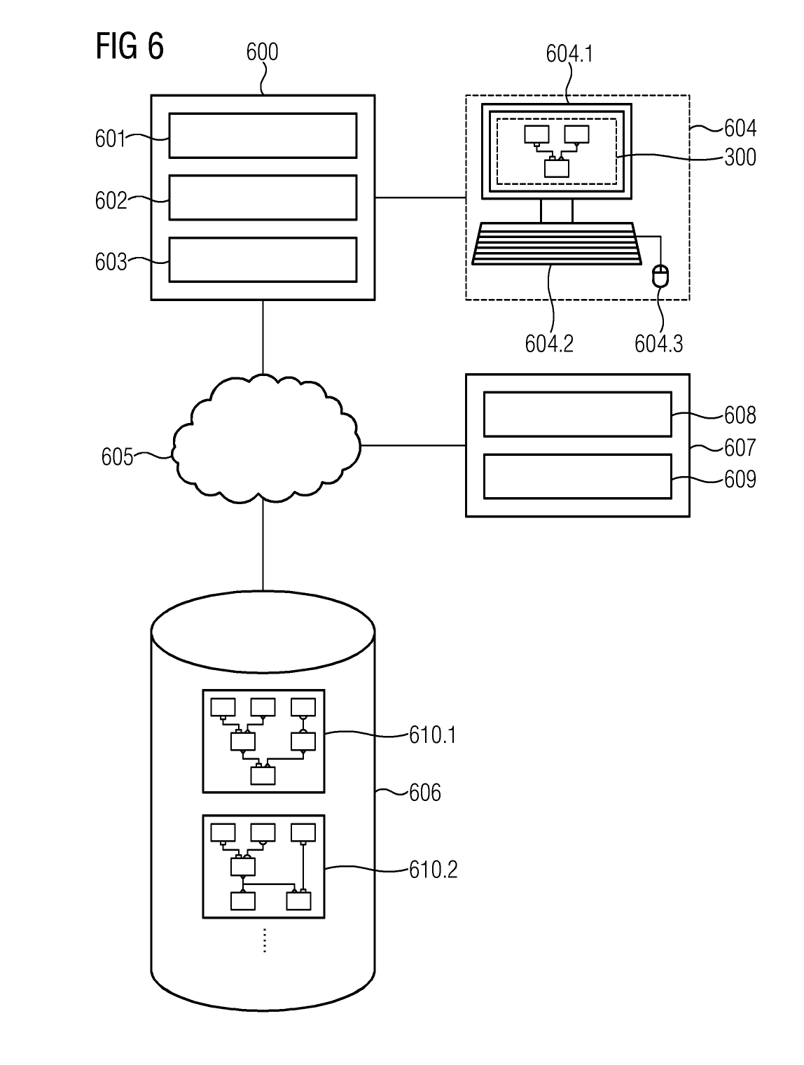

FIG. 6 shows a determining computer 600 for determining selection connection structures 400, 500. The determining computer shown here is configured to carry out an inventive method. This determining computer 600 comprises an interface 601, an arithmetic processor 602 and a storage unit 603. Furthermore, the determining computer 600 is connected to an input and output unit 604. The determining computer 600 for determining selection connection structures is connected over network 605 to a database 606 which contains training program sections 610.1, 610.2. The database can comprise a server for version management (for example by means of the version management programs “SVN” or “git”), although other architectures are also conceivable. Network 605 can be the Internet or an Intranet. The database 606 can also be locally connected to the determining computer 600, however. The database 606 can also be part of the determining computer 600 for determining selection connection structures 400, 500. In the illustrated embodiment the determining computer 600 is connected over the network 605 to an arithmetic server 607. The arithmetic server 607 comprises a server-arithmetic unit 608 and a server-storage unit 609. In the illustrated exemplary embodiment of the determining computer 600 the flow diagram from FIG. 1 is implemented, and determining DET of the first connection structures and calculating CALC of the weighting factors is carried out on the server-arithmetic processor 608 of the arithmetic server 607. The first connection structures and the associated weighting factors are saved in the server-storage unit 609, although they can also be transmitted by means of the network 605 into the storage unit 603.

The determining computer 600 for determining selection connection structures 400, 500 and/or the arithmetic server 607 can, in particular, be a computer, a microcontroller or an integrated circuit. Alternatively, can the determining computer 600 and/or the arithmetic server 607 can be a real or virtual cluster of computers (an English term for a real group is “cluster”, an English term for a virtual group is “cloud”). An interface 601 can be a hardware or software interface (for example PCI bus, USB or Firewire). An arithmetic processor 602 and/or a server-arithmetic processor 608 (and any other processor described herein) can have hardware elements or software elements, for example a microprocessor or what is known as an FPGA (Field Programmable Gate Array). A storage unit 603 and/or a server-storage unit 609 can be implemented as a non-permanent working memory (Random Access Memory, RAM for short) or as a permanent mass storage device (hard disk, USB stick, SD card, Solid State Disk). An input and output unit 604 comprises at least one input unit and/or at least one output unit. In the illustrated embodiment, the input and output unit comprises a screen 604.1, a keyboard 604.2 and a mouse 604.3. In the illustrated exemplary embodiment, the screen 604.1 is designed to display a graphics computer program 300.

Pseudo code is presented in Tables A, B and C, and this implements various exemplary embodiments of the method.

TABLE A
Pseudo code for the method steps DET and CALC in the
exemplary embodiment of FIG. 1

| | |
|---|---|
| A.1 | first_modules = empty_list( ) |
| A.2 | for ts in training_snippets: |
| A.3 | first_modules.append(ts.modules( )) |
| A.4 | first_modules = first_modules.unique( ) |
| A.5 | weights = empty_dictionary( ) |
| A.6 | for fm in first_modules: |
| A.7 | weights[fm] = empty_dictionary( ) |
| A.8 | for fm in first_modules, for ts in training_snippets: |
| A.9 | if fm not in ts: next ts |
| A.10 | structs = ts.connection_structures(fm) |
| A.11 | for struct in structs: |
| A.12 | if struct in weights[fm]: |
| A.13 | weights[fm][struct] += ts.snippet_weight( ) |
| A.14 | else: |
| A.15 | weights[fm][struct] = ts.snippet_weight( ) |
| A.16 | for fm in first_modules: |
| A.17 | weights[fm].sort_dict_by_value( ) |

Table A shows the pseudo code for method steps DET and CALC of the flow diagram shown in FIG. 1. In the lines of code A.1 to A.4 a list “first_modules” is generated which contains all modules which are contained in the training program sections “training_snippets”. For this, firstly “first_modules” are generated as an empty list A.1, and for each training program section “ts”, the modules of “ts” are appended to the list “first_modules” A.3. Finally, modules that occur several times are removed from the list “first_modules” A.4. Alternatively, it would also be possible in this step to evaluate the frequency of the occurrence of a module in the graphics training program sections, and perform the following pre-calculations for only a small volume of the most frequently occurring modules.

Then in the lines of code A.5 to A.7 the object “weights” is applied as an associative data field of associative data fields. The English terms “dictionary” (for example, in programming language python) or “map” (for example, in programming language C++) are also known for the term associative data field. An associative data field comprises a volume of key-value allocations, it being possible for the value to be retrieved by specifying the key in square brackets.

In pseudo code a nested loop follows over all first_modules “fm” in “first_modules”, and over all training program sections “ts” in “training_snippets” A.8. If the first module “fm” is not contained in a training program segment “ts”, the next iteration of the nested loop is called up A.9. If the first module “fm” is contained in the training program section “ts”, all first connection structures “structs” of the first module “fm” are determined in the training program section “ts”. The list “structs” contains a first connection structure for each occurrence of the first module “fm” in the training program section “ts”. In the lines of code A.11 to A.15 a check is carried out for each first connection structure “struct” in “structs” as to whether the combination of the first module “fm” and the first connection structure “struct” is already present in the nested associative data field “weights”. If the combination is contained in the nested associative data field “weights”, the associated value is increased by the rating factor “ts.snippet_weight( )” of the training program segment “ts”, otherwise this combination is allocated to the rating factor “ts.snippet_weight( )” of the training program segment “ts”.

In the lines of pseudo code A.16 and A.17 each associative data field “weights[fm]” is ordered according to the values, in other words, according to the weighting factors of the connection structures here.

Using a very similar pseudo code the method can also be carried out without the step of calculating CALC a weighting factor. For this, the lines of code A.12 to A.14 must be removed and “ts.snippet_weight( )” in line A.15 must be replaced by the number 1. Furthermore, the lines of code A.16 and A.17 can be omitted. The structures found in relation to a first module “fm” then correspond exactly to the list of keys of the associative data field “weights[fm]”.

TABLE B
Pseudo code for the method steps REC and SEL-1 in the
exemplary embodiment of FIG. 1

| | |
|---|---|
| B.1 | module_choose = interface.receive_module( ) |
| B.2 | struct_exist = program.connection_structure(module_choose) |
| B.3 | suggested_structs = empty_dictionary( ) |
| B.4 | for struct in weights[choose_module].keys( ): |
| B.5 | if struct.contains(struct_exist): |
| B.6 | suggested_structs[struct] = |
| | weights[choose_module][struct] |
| B.7 | print struct, suggested_structs[struct] |

Table B shows pseudo code for the method steps REC and SEL-1 in the exemplary embodiment of FIG. 1, wherein the pseudo code in Table B is executed according to the pseudo code in Table A and can use the objects declared and/or defined in the pseudo code in Table A. Firstly the selection module “module_choose” is received from the interface “interface” B.1 and the existing connection structure “struct_exist” of the selection module determined in the graphics computer program. Then in B.3 “suggested_structs” is applied as an empty associative data field. This associative data field will save selection connection structures as keys and the associated weighting factor as a value. For all first connection structures “struct” of the selection module a check is then carried out in B.5 as to whether these contain the existing connection structure “struct_exist”. If this is case, the first connection structure “struct” is saved together with its weighting factor in line B.6 and output in line B.7. As a result of the fact that the “weights” have already been sorted in Table A, the selection connection structures are output in B.7 sorted according to the weighting factor.

TABLE C
pseudo code for the exemplary embodiment of FIG. 2

| | |
|---|---|
| C.1 | module_choose = interface.receive_module( ) |
| C.2 | struct_exist = program.connection_structure(module_choose) |
| C.3 | suggested_structs = empty_dictionary( ) |
| C.4 | for ts in training_snippets: |
| C.5 | if module_choose not in ts: next ts |
| C.6 | structs = ts.connection_structures(module_choose) |
| C.7 | containing_structs = empty_list |
| C.8 | for struct in structs: |
| C.9 | if struct.contains(struct_exist): |
| C.10 | containing_structs.append(struct) |
| C.11 | for struct in containing_structs: |
| C.12 | if struct in suggested_structs: |
| C.13 | suggested_structs[struct] += |
| | ts.snippet_weight( ) |
| C.14 | else: |
| C.15 | suggested_structs[struct] = |
| | ts.snippet_weight( ) |
| C.16 | suggested_structs.sort_dict_by_value( ) |
| C.17 | for struct in suggested_structs.keys( ): |
| C.18 | print struct, suggested_structs[struct] |

Table C shows pseudo code for the method steps REC, DET, SEL-1 and CALC in the exemplary embodiment of FIG. 2. The selection modules “module_choose” and the existing connection structure “struct_exist” of the selection module are received in the lines of code C.1 and C.2. The selection connection structures “suggested_structs” are applied in line of code C.3 as an empty associative data field. The selection connection structure is used here as the key of the associative data field; the weighting factor of the selection connection structure is used as the value. For each graphics training program section “ts” in the graphics training program sections “training_snippets”, it is firstly checked in the line of code C.5 whether the graphics training program section “ts” contains the selection module “module_choose”. If this is the case, the first connection structures “structs” of the selection module “module_choose” are called up in the graphics training program section “ts” in line of code C.6. In the lines of code C.7 to C.10, the selection connection structures “containing_structs”, which contain the existing connection structure “struct_exist” of the selection module, are selected from the first connection structures “structs”. Analogous to the lines of code A.11 to A.15, the weighting factors of the selection connection structures “suggested_structs” are calculated in the lines of code C.11 to C.15. The lines of code C.16 to C.18 carry out the same steps as the lines of code A.17, B.4 and B.7.

Although modifications and changes may be suggested by those skilled in the art, it is the intention of the Applicant to embody within the patent warranted hereon all changes and modifications as reasonably and properly come within the scope of the Applicant's contribution to the art.

1. A method for determining selection connection structures, comprising:
in a processor, determining connection structures of at least one module, wherein the connection structures and the module are contained in graphics training program sections;
receiving a selection module and an existing connection structure of the selection module into said processor via an interface, the selection module being contained in a graphics computer program, and the existing connection structure designating the connection structure of the selection module in the graphics computer program; and
in said processor, selecting selection connection structures from among the connection structures of the selection module, wherein each of the selection connection structures comprises the existing connection structure of the selection module.

2. The method as claimed in claim 1, wherein said determining occurs before said receiving, and wherein the module comprises at least a most frequent module contained in the graphics training program sections.

3. The method as claimed in claim 2, wherein the modules comprise all modules contained in the graphics training program sections.

4. The method as claimed in claim 1, wherein said receiving of a selection module occurs before said determining, and wherein the module is the selection module.

5. The method as claimed in claim 1, comprising:
calculating weighting factors of the connection structures or of the selection connection structures based on the graphics training program sections, with the arithmetic processor.

6. The method as claimed in claim 5, wherein the weighting factor of a connection structure relates to at least one weighted relative frequency of the occurrence of the connection structure in the graphics training program sections, wherein the weighting of the relative frequency occurs by means of a rating factor, and wherein the rating factor is associated with a graphics training program section.

7. The method as claimed in claim 6, wherein a same rating factor is associated with each graphics training program section.

8. The method as claimed in claim 5, wherein the weighting factor of a connection structure is calculated by a self-learning system based on the graphics training program sections.

9. The method as claimed in claim 8, wherein the self-learning system comprises an artificial neural network that, in a training phase, maps graphics training program sections without the selection module on graphics training program sections comprising the selection module and comprising a connection structure of the selection module.

10. The method as claimed in claim 9, wherein said connection structures are first connection structures and said module is a first module, comprising:
in said arithmetic processor, making a second selection of a second selected connection structure from the selection connection structures; and
in said arithmetic processor, supplementing the connection structure of the selection module based on the selected connection structure.

11. The method as claimed in claim 10, wherein the second selection of the selected connection structure is made from the selection connection structures using the weighting factor.

12. The method as claimed in claim 1, wherein a connection structure of a first module comprises only second modules, which are contained in a vicinity of a first order of the first module, and all connections between the first module and the second modules.

13. A determining computer, comprising:
a processor configured to determine connection structures of at least one module, wherein the connection structures and the module are contained in graphics training program sections;
an input that receives a selection module and an existing connection structure of the selection module into said processor via an interface, the selection module being contained in a graphics computer program, and the existing connection structure designating the connection structure of the selection module in the graphics computer program; and
said processor being configured to select selection connection structures from among the connection structures of the selection module, wherein each of the selection connection structures comprises the existing connection structure of the selection module.

14. A non-transitory, computer-readable data storage medium encoded with programming instructions, said storage medium being loaded into a computer and said programming instructions causing said computer to:
determine connection structures of at least one module, wherein the connection structures and the module are contained in graphics training program sections;
receive a selection module and an existing connection structure of the selection module into said processor via an interface, the selection module being contained in a graphics computer program, and the existing connection structure designating the connection structure of the selection module in the graphics computer program; and
select selection connection structures from among the connection structures of the selection module, wherein each of the selection connection structures comprises the existing connection structure of the selection module.
